(19) United States
(12) Patent Application Publication
(10) Pub. No.: US 2002/0133264 A1
(43) Pub. Date: Sep. 19, 2002

(54) Virtual reality system for creation of design models and generation of numerically controlled machining trajectories

(75) Inventors: Bilal Y. Maiteh, Royal Oak, MI (US); Ming C. Leu, Rolla, MO (US); Denis L. Blackmore, Maplewood, NJ (US)

Correspondence Address: KLAUBER & JACKSON, 411 HACKENSACK AVENUE, HACKENSACK, NJ, 07601

(73) Assignee: New Jersey Institute of Technology

(21) Appl. No.: 09/770,929

(22) Filed: Jan. 26, 2001

(51) Int. Cl. G06F 19/00

(52) U.S. Cl. 700/182; 700/86; 700/83

(57) ABSTRACT

A system for using a virtual reality environment to create a design model and generate numerically controlled (NC) machining trajectories for use in fabrication of the model. The model is created in a virtual environment by carving a workpiece with one or more tools, each of which may have the geometry of a hand tool (e.g. a knife) or a machining tool (e.g. milling cutter). The selection and manipulation of virtual objects is performed in virtual space. Swept volumes of the virtual objects are generated using a solid modeling system according to the shape of the virtual objects and their trajectories, and Boolean operations are performed on the swept volumes and the initial virtual stock (workpiece) to create the design model. If the virtual object has the geometry of a computer numerical control (CNC) machining tool, the real NC machining trajectories for making the design object can be generated from the virtual object's movements, during the design model creation with the virtual reality environment. In order for the virtual object to simulate the real machining tool, constraints are applied on the movements of the user to represent the physical effects and limitations of the real machining process. The trajectories of the machining tool in the virtual reality environment are post-processed by computer software, which converts the user movement (position and orientation) of the virtual tool to NC trajectories after taking the user movement and the machine parameters and conditions into consideration.

### BACKGROUND OF THE INVENTION

1. Field of the Invention

The present invention relates generally to a system for creating a design model, and machine instructions for building the same, using a virtual-reality-environment user interface. More particularly, the present invention relates to a system for creating a design model and generating NC machining trajectories in which a user's interactions in a virtual reality environment allow the user to create design models and to generate the NC machining trajectories during the design process in real time.

2. Description of the Related Art

Growing interest in virtual reality (VR) techniques over the past few years has led to numerous types of computer applications that utilize a virtual reality interface; such computer applications include, but are not limited to, landscaping, interior design, and video games. In the field of Computer-Aided-Design (CAD) and Computer-Aided-Machining (CAM), engineers have been working with computer applications for many years that simulate the machining instructions used to build design models, but these methods lack the interactive capabilities available in VR environments. This is due in-part to the fact that such computer applications are adapted for a conventional computer interface having a keyboard, video screen and a point and click device, such as a mouse or the like.

Numerically Controlled (NC) machines, such as end milling NC machines, are computer-controlled machines that move a tool, such as a cutter, drill or lathe, through a precise sequence of tool motions under the direction of a computer program. First-generation machines were hardwired to perform specific tasks or programmed in a very low-level machine language. Today, such machines are controlled by their own microcomputers and programmed in high-level languages, such as APT and COMPACT II, which automatically generate the tool path or trajectories (physical motions required to perform the operation) hereinafter referred to as trajectories. The term “Numerical Control” was coined in the 1950s when the instructions to the tool were numeric codes. Just like the computer industry, symbolic languages were soon developed, but the original term remained. The term “NC” as used herein broadly refers to any and all computer-controlled machines adapted to move a tool.

While NC machines are widely used to machine parts in the automobile, aerospace, mold/die making, and many other industries, it is often difficult to achieve high productivity with NC machines partly because of the error in the generation of NC machining trajectories. This error is a function of the complexity in the creation of the design model and the traditional lack of integration of this process with the determination of the accurate parameters of the ultimate manufacturing process.

More particularly, the conventional process of design model creation and NC machining trajectory generation often begins with creating rough sketches of the design product to demonstrate the idea. Since existing CAD (Computer Aided Design) packages require training and skill on the part of the user to create a good design model, the rough sketches are typically sent to professional engineers to develop the design model using a CAD software package. The engineer, working on the design model, usually does not consider machining issues during the design process. The design model is viewed as a three-dimensional (3-D) perspective image on the two-dimensional (2-D) screen and may be modified to meet the application requirements of the ultimate product that is the object of the design model. At this stage the engineer cannot be sure that the design model can be manufactured. After the design model is approved, a CAM (Computer Aided Manufacturing) software package can be used to generate a NC machining program. Considerable experience, skill and training in manufacturing are needed to use the existing CAM packages effectively. After the NC program is generated using CAM, simulation and verification are needed to check the difference between the design model and the simulated-machined model. Modification of the NC program may be needed to ensure such differences stay below the specified tolerances. If a CAM package cannot generate the NC program for a given design model, then the model needs to be modified using the CAD package. When the design models have complicated shapes, much skill and time is required to produce an acceptable model and the NC machining program for the model.

Tool path generation associated with NC machining programs has so far been approached using automatic programming systems. An automatic programming system can only search and identify particular types of patterns already known and stored in the data files of the system. The selection of the particular tool path pattern suitable for a given work piece may need to be determined from a consideration of tool paths not recognizable by the automatic system, and thus, such selection must be made manually by the machine operator, possibly from direct experience. Most important in tool path generation are the problems related to collision between the environmental model and the tool such as:

1 The problem of recognizing the regions where cutting is not possible in a designated tool approach direction due to range of motion limitations in the cutting tool.

2 The problem of collision between the environmental model including the work piece and the portion the tool not involved in cutting, also due to range of motion limitations in the cutting tool.

3 The problem of recognizing an inter-surface relationship between a region to be cut which may be comprised of several surfaces, and the cutting edge of the tool.

In order to reduce the time and cost of designing a model, generating the NC program, and solving the above problems in tool path generation, the need exists for an improved system for cooperatively designing the model and cutting tool trajectories.

Some known methods for NC generation, simulation and verification are disclosed as follows:

One method for generating tool paths in a CAD/CAM system uses the relation between a work piece model and a tool model, which can be checked for collisions by calculating the normal direction of the surface corresponding to the tool radius. A method of the type exemplary of this approach is disclosed in U.S. Pat. No. 4,837,703.

In a system for automatic generation of tool path data, a machining tool path is positioned within a three-dimensional rectangular coordinate system, which corresponds to a machine coordinate system for NC machining. The tool path is established along a first coordinate axis. The tool path is shifted to an adjacent path along the first coordinate axis in a second-axis direction. The shifting pitch of the path corresponds to the interval of the path along the first coordinate axis. The tool is shifted in a third-axis direction during travel along the path defined in the first- and second-axis directions. U.S. Pat. No. 4,789,931 discloses a system of this type.

Another system and method for tool path processing offsets a tool path from a given geometric sequence, avoiding tool interference and accounting for coincident tool paths. It guides an NC machine tool during the manufacturing process. In this invention, a computer-aided-manufacturing system defines or allows definition of a pattern to be machined by a tool having an offset and analyzes the pattern for points of intersection. The method partitions the pattern into contiguous segments between points of intersection, structures a list of the segments ordered between intersection points, defines tool path chains corresponding to the list, validates the tool path chains to define valid tool paths, and then guides the movement of the tool along a valid tool path. A system exemplary of this system and method is disclosed in U.S. Pat. No. 4,951,217.

The above examples employ a conventional CAD system to create the design model and generally rely on the assumption that the design model thus created can be manufactured and the tool path can be generated. Then they use the CAM system to simulate and verify the NC machining tool path. These systems do not permit much interactive input by the user during the design model and NC trajectory creation process.

In other systems utilizing verification methodologies, NC verification software is used to determine the accuracy of the NC program and convey the results to the user. Pixel-level calculation in localized regions provides three-dimensional surface coordinates and their corresponding normal vectors, which are mapped onto a two-dimensional mill-axis space. Swept volumes are then processed in this mill-axis space to determine how surface points are affected, and the appropriate surface normals are intersected with the swept volumes to calculate the depth of cut. This method is restricted to user-selected views and 3-axis milling operations, and suffers from accuracy problems related to resolution of the graphics.

In another example of verification systems, a 5-axis verification system is created using a full-depth pixel representation of the part being machined. The swept volume of the tool is computed as a parametric boundary surface, from which a polyhedral model is developed. Then scan rendering is used to create a full-depth pixel image. The pixel image is subtracted from the work piece in the graphic display, by comparing the sorted depth information of the new primitive with the current display buffer, thus creating the updated model. Positional tolerance verification is provided in this system by checking the tool path against the true model. Ray-casting techniques are also used to create a pixel image. The problems with this method are that a great deal of time is required to create the pixel image since it is constructed pixel by pixel. Only one view can be selected at a time and the graphic resolution plays a large part in the representation of the work piece.

Current CAD/CAM and manufacturing simulation tools provide the designer with valuable information, but they are incapable of providing the wealth of information available through the use of VR technology. Current CAD/CAM software such as Pro/Engineer and I-DEAS Master Series provides powerful design environments using parametric design methods and solid modeling. However, this software suffers from the drawback that the designer is limited to the size of the viewing area of the monitor being used. A large part or assembly must be viewed in either a scaled-down view to analyze the entire design or in true scale with limited view. In this connection, prior disclosures utilizing the virtual environment have focused on the development of VR as an aid in the verification of the accuracy and consequent viability of preexisting NC milling routines (U.S. Pat. No. 5,710,709). Also, haptic devices have been operated interactively with CAD systems, as demonstrated by the manipulation of a three-dimensional object in a CAD environment using a force-feedback interface (U.S. Pat. No. 5,973,678). Neither of these disclosures either appreciates nor suggest the method and system of the present invention.

The method presented in this invention differs from existing work being done in several ways, most importantly in the manner in which the user interacts with the environment. In the method described, the user interacts with virtual tools and virtual objects in a natural way within a three-dimensional VR environment, and importantly, is able to develop realistic parameters for actual manufacturing of the workpiece. The system and method may be used for the development of the design or for the development of the manufacturing parameters. In either instance, the real-time VR environment and its precise replication of the actual manufacturing environment assure that the design and the manufacturing protocols of the product in object will require little or no revision as proposed, and that manufacturing of the product can be rapidly implemented. It can therefore be readily appreciated that the present method and system have immediate and significant positive impact on design and manufacturing activities.

### OBJECTS AND SUMMARY OF THE INVENTION

It is a principal object of the present invention to provide a method for increasing design quality and productivity by making use of virtual reality technology to replicate the multi-sensual reality of the manufacturing experience in real time, in conjunction with the operation of a CAD-CAM system.

It is a further object of the invention to create a more natural and intuitive environment in which to employ CAD systems that facilitate accurate development of design prototypes and manufacturing protocols.

A yet further object of the invention is to provide a method for creating design models.

A still further object of the invention is to provide a method for generating NC machining trajectories directly from the model design process.

Another object of the invention is to reduce the time and the cost of the design to machining process by performing the design and NC machining trajectory generation functions simultaneously.

A further object of the invention is to improve design quality by allowing multi-user participation in the design model process through the Internet and more natural interaction between the user and the design process in the VR environment.

An advantage of the present invention is that it provides a more flexible three-dimensional environment for the user in which to exercise creative design techniques.

Another advantage of the present invention is that it generates NC machining trajectories faster and easier than existing CAD/CAM systems.

It is yet another advantage of the present invention that many steps in the tool path generation process are eliminated, as they are automatically performed during the design phase of the method.

This invention describes a method for creating design models in a VR environment that provides real time interaction between the designer/operator and the workpiece, which accurately simulates the manual design and manufacturing process. The design model creation can be flexibly done by using a variety of virtual tools to carve a workpiece. The designer initializes the stock in the solid modeling system. Then the designer selects and grips a virtual tool with a haptic device and manipulates this virtual tool in the VR environment as one would manipulate the physical tool with a comparable physical workpiece, to generate trajectories for this tool. Since the dimensions of this virtual tool are known and the trajectories of this tool are measured, the swept volumes of the virtual tool can be generated in a solid modeling system. Then the solid modeling system performs Boolean operations between these swept volumes and the initial stock to create the design model.

The virtual tool may have the geometry of a hand tool (e.g. a knife) or a machining tool (e.g. a milling cutter). When the virtual tool has the geometry of an NC machining cutter, the design model is created in a manner that actually simulates the machining process.

The VR environment enables the user to do the following:

1 Initialize the three-dimensional virtual solid workpiece by using the input system.

2Create, select, and grip the virtual objects, which simulate the real tools.

3 Provide constraints on the user movement by applying a force through the haptic interface, where the constraints simulate the physical limitations of the real machine.

4 Manipulate (sweep) the virtual objects (tools) within the constraints in the virtual environment continuously.

5 Model in-process virtual work piece geometry as a solid by subtracting the swept volume of the virtual tool from the current virtual work piece.

6 Record the position and orientation of the virtual tool during its motion using VR hardware devices, and by doing this, develop full-scale manufacturing parameters that can be directly inputted or applied to the operation of automated manufacturing operations, such as NC milling machinery.

The applications of this invention are far-reaching and significant, as they profoundly impact all manufacturing activities. Product design and manufacturing implementation are made more efficient as both stages of product creation can be accomplished simultaneously and with far greater accuracy and consequent reduction in design modification efforts during product development. Such costs as manpower, material, space utilization and energy consumption during the development stage can be significantly reduced.

### BRIEF DESCRIPTION OF THE DRAWINGS

FIGS. 1A and 1B are schematic illustrations of the virtual reality environment for design model creation and NC machining trajectories creation.

FIG. 2 is a schematic illustration similar to that of FIG. 1, showing the virtual reality environment for distributed design and manufacturing to allow two or more designers to collaborate on the design of a single workpiece or project.

FIG. 3 is a flow diagram depicting the architecture of the system of the present invention.

FIG. 4 is a flow diagram depicting the general processing flow of model design in accordance with the invention.

FIG. 5 is an illustration of the physical model 40 presented in FIG. 3.

FIG. 6 is a flowchart of the physical simulation model according to an embodiment of the present invention.

FIG. 7 is a flowchart illustrating the integration of the SDE method with the Ray Casting technique.

FIG. 8 illustrates an object boundary partition, which is partitioned into ingress, egress and grazing points.

FIG. 9 is a flowchart of the swept volume generation.

FIG. 10 is an example of conversion from a solid model to a discrete space model.

### DETAILED DESCRIPTION OF THE PREFERRED EMBODIMENT

The system comprising the present invention includes and is based on operation within a Virtual Reality (VR) environment system and method to both create a design model and to generate NC machining trajectories that are directly commercially viable. The VR environment system is characterized by its utilization of an algorithm using the Sweep Differential Equation approach for the definition and representation of the swept volume of a moving solid. The utilization of the swept-volume computation by the herein method and system facilitates the application of the system to develop commercially accurate manufacturing protocols for the creation of e.g. freeform surfaces by a machining method such as NC machining. The algorithm is expressed in computer code that is integrated with a commercially available CAD/CAM system, whereby the use of the system for the herein method comprises the operation of the appropriate machine or machines in communication with and under instruction from the software of the invention derived from machining procedures.

The VR environment includes hardware devices and software programs. The VR environment is used to enable the user to interact with the virtual workpiece and virtual tools. Data generated from the interaction of the user with the VR environment is used to create a virtual design model and to generate NC machining trajectories from the design process. The VR environment hardware is typically comprised of two groups of devices, and the type or types selected depend on the uses to which they will be put.

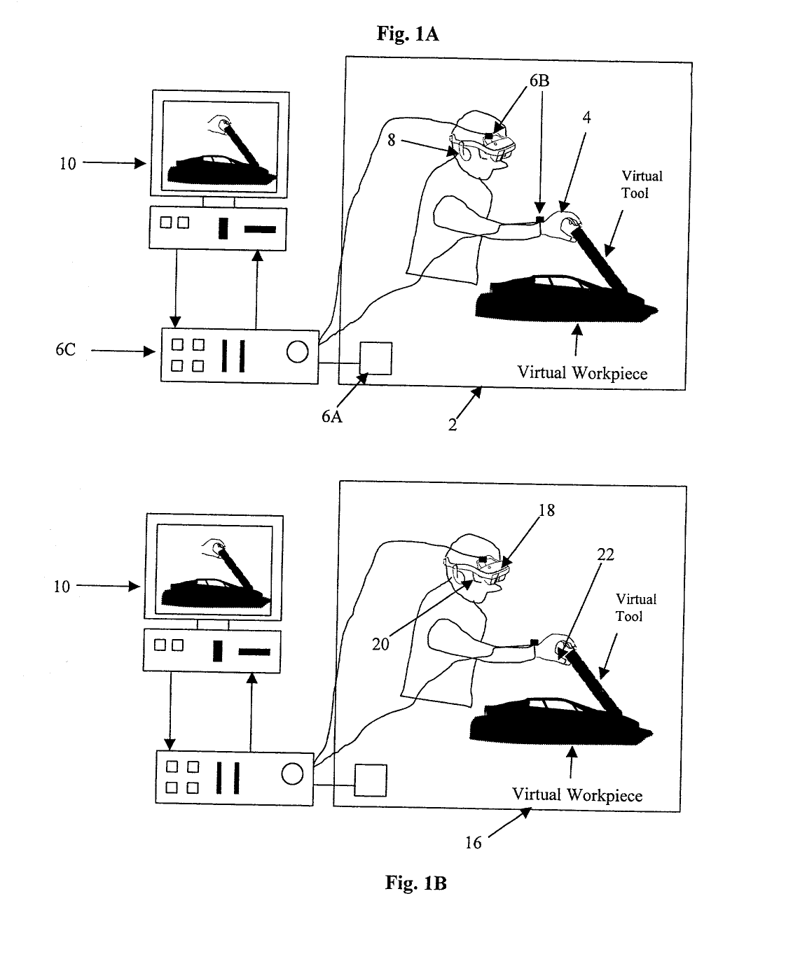

With reference to FIGS. 1A and 1B, the first group of VR instruments consists of a combination of input devices 2, 16. The input devices are used to assist in the communication of the user's ideas into the computer representation. The input devices may include a pointing device 4, 22 a tracking device 6, and a speech recognition device 8.

The purpose of the pointing device 4, 22 is to size the virtual object and navigate it through the virtual space. In this invention the designer or operator can use the pointing device 4, 22 to create a design model and assign the material type of the virtual work piece. The virtual workpiece can be placed in a location that is convenient for interaction.

Also the user can use the pointing device to select virtual tools, which may simulate general-purpose hand tools, or real tools in NC machines. Moreover, the pointing device is used to grip/activate and to manipulate (sweep) the virtual tools by providing a feedback force model in the output device group and the tracking device. There are different pointing device types, such as the joystick, Spaceball™, flying mouse, glove and mechanical devices. Each type of pointing device has limitations and advantages in terms of the degree of freedom, the accuracy, and the size and weight of the device. The limitations of the chosen pointing device may be used as constraints, where these constraints simulate the actual machining process. For example, if the user needs to perform three-axis machining, a pointing device with three degrees of freedom for positioning can only be selected. The limitations of input devices are useful because they provide a realistic simulation of design object creation processes.

Generally, the tracking devices 6 are used for two purposes: (a) to represent a portion of the user's body in the virtual environment and (b) to update the image display. For representation, the trackers can be mounted on the pointing device or a convenient part of the user's body. The position and orientation of the tracking device are then used by the software to generate a replication of the tool in the virtual environment. For display updates, the tracker is usually mounted on the user's head or tracks the line of sight, and the data collected is used as input for the updated graphical display. In this embodiment of the invention method, a relation model is constructed between the tip position of the virtual tool and the position of the tracking device and another relation model is constructed between the orientation of the virtual tool and the orientation of the tracking device. These relation models are used to generate the position and orientation data for the virtual tool for each movement of user's hand. These data represent the tool path trajectory for the virtual tools if the virtual tools have the geometry of real CNC machining tools. By combining the machine parameters and the virtual tool geometry and parameters to the position and orientation data, the NC program for the design model can be generated by the VR environment. This NC program can be used for the actual machining process after some post-processing includes trajectory smoothing.

The tracking device typically uses one of the following technologies: ultrasonic, magnetic, mechanical or source less. The magnetic system has acceptable performance in terms of the virtual space volume and accuracy. This system consists of three distinct components: a transmitter (6A) to emit a pulsed DC magnetic field, a receiver (6B) to track the position and orientation, and an ascension unit (6C) to communicate sensed information to the host computer (10).

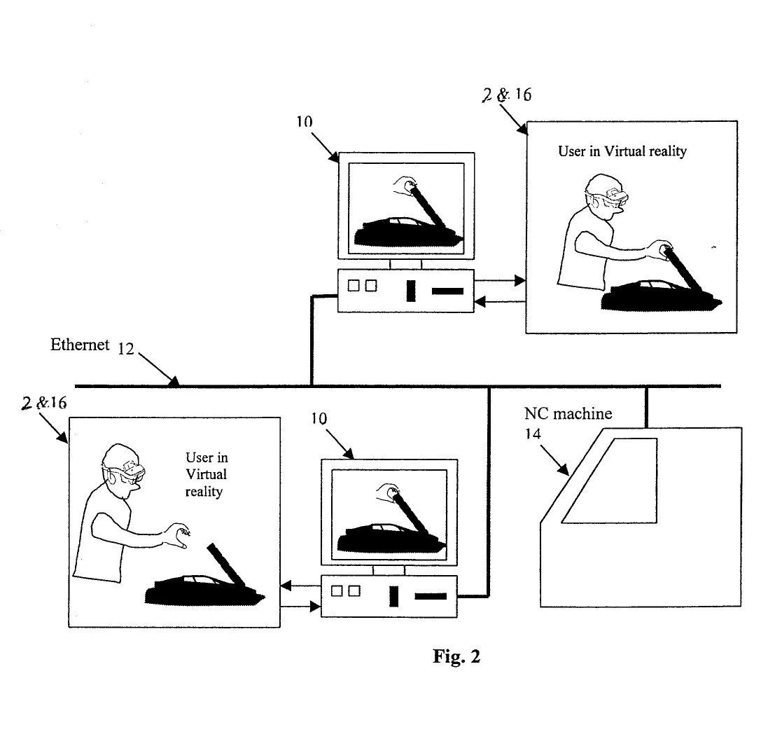

A speech recognition device 8 can be used for communication with other users in a natural way. This device enables remote natural communication between users participating in the design model creation and NC machining trajectories generation process through the Ethernet 12, as illustrated in FIG. 2. Also the NC program can be sent directly to the Numerical Control (NC) Machine 14.

As illustrated in FIG. 1B, the second group of VR instruments consists of a combination of output devices 16. The output devices are used to present information generated by the computer software. These devices provide output in several forms including visualization output 18, auditory output 20, and haptic output 22.

A visualization device 18 provides a graphical display of the output from a geometry modeler (in computer software) as a three-dimensional object in a VR environment. There are several classes of graphical display systems available, which include head mounted display devices (HMD's), multi-wall displays (CAVE's), and the use of shutter glasses in combination with traditional CRT displays.

The main feature of CAVE's is the enclosure of the users in a three-dimensional structure which has images displayed on wall surfaces. CAVE is a sophisticated system developed at the University of Illinois-Chicago. Vision Dome is the commercial name for CAVE, which is available from Alternate Realities Corporation at a very high cost. The main advantage of a CAVE/Dome display is that it can immerse several people at once in the virtual environment. The disadvantages of this approach are the high cost, large space requirement, and rather poor resolution of the images.

Shutter glasses are used to provide a three-dimensional image to the user by sequentially blocking one eye's view of two images displayed on a traditional monitor. The images sequentially displayed in synchronization with the shutter glass lens closing are assembled into a three-dimensional representation of the object. The disadvantages of this approach are that the resolution of the images is limited by the monitor hardware and that the images are confined to a relatively small portion of the user's visual field of view, resulting in a low immersion effect.

The Head Mounted Display (HMD) 18 is a device that is used to provide a graphic display and is worn by the user like eyeglasses. HMD provides a very immersive environment because it blocks out external visual stimuli. HMD includes two miniature display screens and an optical system that channels the images from the screens to the eyes, thereby presenting a stereo view of the virtual world. A motion tracker continuously measures the position and orientation of the user's head and allows the image-generating computer to adjust the scene representation to the current view. Consequently, the user can look and walk through the surrounding virtual reality environment.

The second output device is the audio output device 20. To achieve a realistic simulation of three-dimensional sound effects, a sound card can be used. In this invention, the audio output device can be used to simulate material removal sound and the collisions between the user's body and the other objects. The sound effects provide additional constraints that more realistically simulate an actual machining process.

The last instrument in the output system is the haptic device 22. Haptic devices provide a physical sensation of touch. Some haptic devices provide a force feedback to a finger, the hand, or the hand and arm. Also, some of them can provide a tactile feedback. Some of them can provide the user with a three-dimensional display of a surface in the virtual environment. These devices can give the user an extremely high level of realistic haptic feedback in conjunction with a VR interface. In component creation and modification tasks, haptic feedback could be used to create an illusion that the user is forming the component from some real material. For assembly of components, haptic feedback can realistically simulate assembly modeling at a much earlier stage in the design process than is currently possible.

Force feedback is provided by devices designed to create a computer controlled force sensation to the user's hand or arm. Some of these devices include joysticks, robotic devices, exoskeletons, pen devices and finger tip thimble-activated devices. Exoskeletons consist of a robotic mechanism that surrounds the outer surface of the hand, and may provide force and/or tactile feedback to the hand or finger tips. One important advantage of this device is that the feedback forces may closely resemble those actually felt during hand manipulation tasks. Another advantage is that, because these systems accurately mimic the hand and finger joint motions, they may be used to track the hand position for its representation in the virtual environment. Several commercial exoskeleton products are available from Exos, Inc. (Woburn, Mass.) and other companies. The combination of a robotic arm and an exoskeleton may be available commercially from Sarcos, Inc. (Salt Lake City, Utah).

Another type of haptic device that can be used in this invention is the tactile feedback device. This device provides various parts of the hand with a simulated feeling of touching a real object. This is sometimes referred to as sensory substitution, in that the sense of force is created with some other sensation such as vibration, temperature, or pressure from inflatable balloons. “Virbrotactile” output is commercially available from Virtual Technologies (Palo Alto, Calif.) in a product called the “Cybertouch” glove. The basic product is a data glove, and the “Cybertouch” feature provides vibration output to the fingers and palm.

The purposes of using haptic devices in this invention are: (a) to simulate the selection and gripping of virtual tools, (b) to simulate the contact of the virtual tools with the virtual workpiece, and (c) to simulate the real machining process effects and limitations.

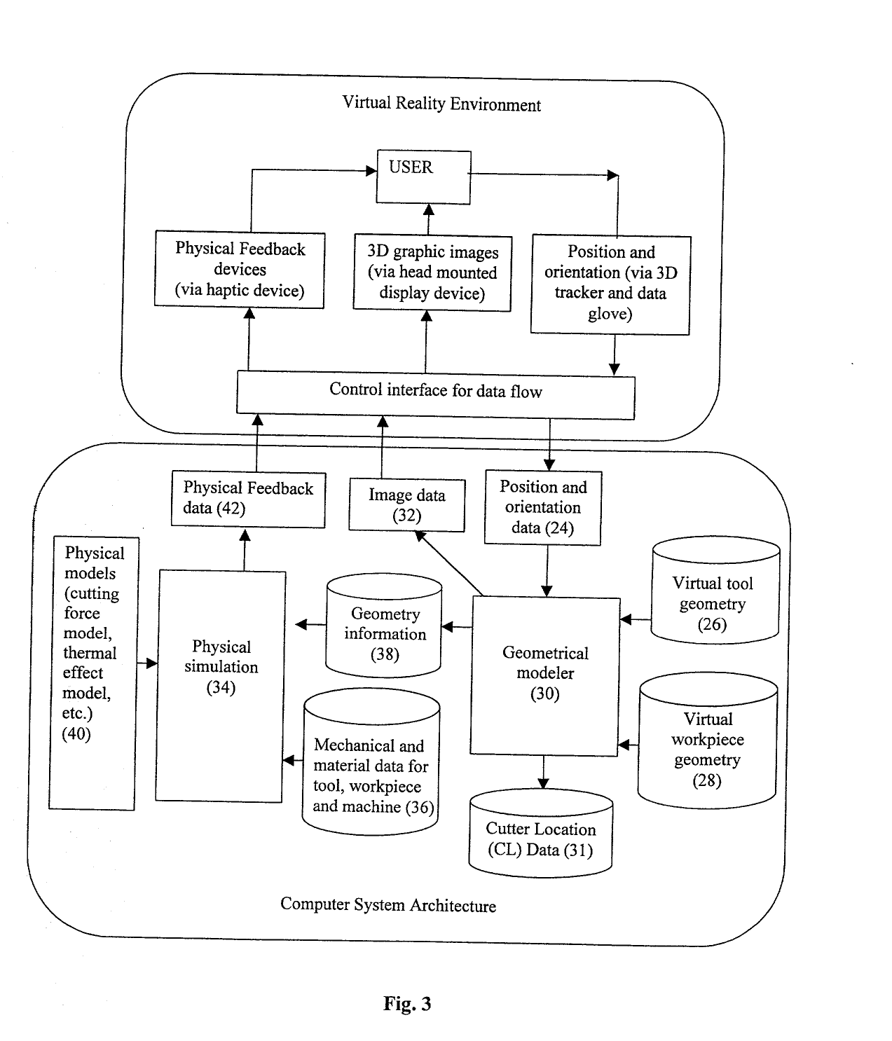

With reference to FIG. 3, the NC machining trajectory generation method uses the position and orientation data 24 from the tracker devices, the virtual tool geometry 26, and the machine parameters as inputs. This method constructs a relationship between the position and orientation data of the virtual tool and the tracker device. The user's finger mounted with the tracker device represents the virtual tool, and thus the position and orientation data of the finger provide the position and orientation data of the virtual tool. By combining the machine parameters and the position and orientation data from the tracker device, a NC program is generated for each movement of the user's finger.

In addition, the design model creation method uses the following as inputs: the geometric models of the virtual workpiece 28, virtual machine, virtual tool 26, and the position and orientation data of virtual tool. The changes of the virtual workpiece geometry with the movements of the virtual tool and the removed material are created using a solid modeling system 30. The results of the design model creation method provide the geometric information 38 for collision check in the actual machining of the design model and image data 32 for the design model. The details of the operation of this aspect of the method and corresponding system presented below and elsewhere herein, are illustrative of a characterizing aspect of the invention.

Moreover, the design model creation method can be realized via Boolean subtraction of the virtual tool swept volume from the virtual workpiece. Using the virtual tool geometry and the virtual tool path, the virtual tool swept volume is constructed. A geometry modeler such as the commercially available “ACIS” package from Spatial Technology (Boulder, Colo.) can be used to represent the virtual tool swept volume and virtual workpiece and perform the necessary Boolean operations for the creation of the model.

In addition to the geometric information 38 provided by the design model creation method, the physical simulation 34 is performed by using the mechanical and material data 36 associated with the virtual workpiece and the virtual tool. In the physical simulation, various process parameters are estimated based on the corresponding physical models 40. Physical simulator software uses the available models for computing thermal effects, cutting forces, tool breakage, tool wear, chatter vibration and other physical effects 42. The purpose of this physical simulator is to create effects and constraints corresponding to the actual machining processes. These effects and constraints can be realized to provide feedback to the user in three ways: graphically, physically, and audibly.

The first way is a method that realizes machining effects and constraints graphically. The color of the virtual tool can be programmed to change continuously during the design creation process, where the color changes represent the mechanical and thermal stresses on the virtual machine tools. The virtual tool geometry can also change continuously during the design process to indicate tool deflections. The graphic display of the tool can also include the simulation of tool breakage, excess tool wear, chatter vibration, etc.

The second way is a method that employs haptic devices. The physical simulator computes the heat generated by the machining process. The computed amount of heat (after scaling) can be sent to the user's hand by generating heat in the haptic device to simulate heat generation in the machining process. The physical simulator also computes the cutting force. The computed cutting force (after scaling) can also be transferred to the haptic device, which increases or decreases the feedback force to reflect the increase or decrease of cutting force.

The third way is a method that employs audio devices. The sound of the real machining process can be simulated and sent to the user via sound effects by, for example, including a sound card in a computer, thereby indicating errors and limitations in the machining process.

The main purpose of these methods is to send a feedback to the user to simulate the limitations of the actual machines, which are used in the process of machining the workpiece to obtain the design part. If the feedback is ignored by the user, then the virtual reality environment can be set to freeze with all the information saved.

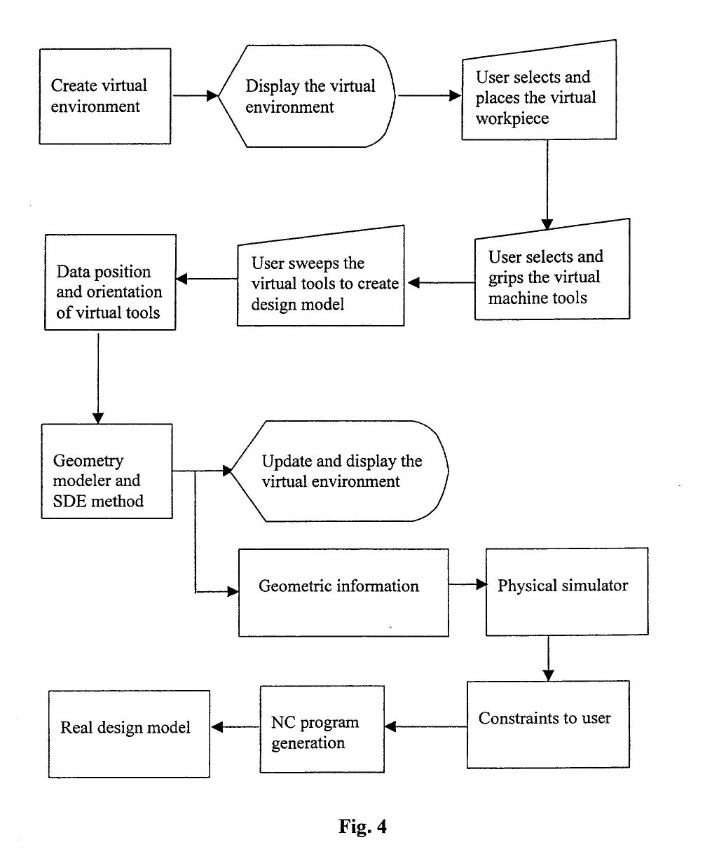

As shown in FIG. 4, the processing flow of design model creation and NC machining trajectories generation in the virtual reality environment is as follows:

1. Create the virtual environment by the geometry modeler.

2. Display the three-dimensional virtual environment for the user via the HMD device.

3. The user selects the virtual workpiece, which is created by the geometry modeler, and places the virtual workpiece in the virtual environment.

4. The user selects and grips the virtual machine tools using the haptic device.

5. As the user manipulates the virtual tool in the virtual environment to create the design model, the tracker device records the position and orientation of the virtual tool.

6. The geometry modeler (which supports Boolean operations) generates swept volumes of the virtual tool and performs Boolean operations between the virtual tool swept volumes and the virtual workpiece. This simulates the geometric changes of the virtual workpiece corresponding to movements of the virtual tool. The changes in the virtual workpiece represent the design model creation process.

7. The HMD device updates the three-dimensional images of the changing virtual workpiece (design model).

8. The geometric information from the geometry modeler and the material data of the tool and the workpiece are used as inputs to the physical simulator software.

9. The physical simulator software computes the heat, cutting force, tool breakage, tool wear, chatter vibration, etc.

10. The results (which represent the machining effects and the limitations of the real machine) of the physical simulator software are transmitted to the user by the methods described above.

11. From the machine parameters, the geometry of the virtual tool, and the position and orientation of the virtual tool, the NC program is generated after taking the user (designer) movements and the machine conditions into consideration.

12. The NC program and the geometric models of the virtual workpiece and virtual tool are used as inputs for creating the real design model.

### Physical Simulation Model (Example: MODELING OF CUTTING FORCE)

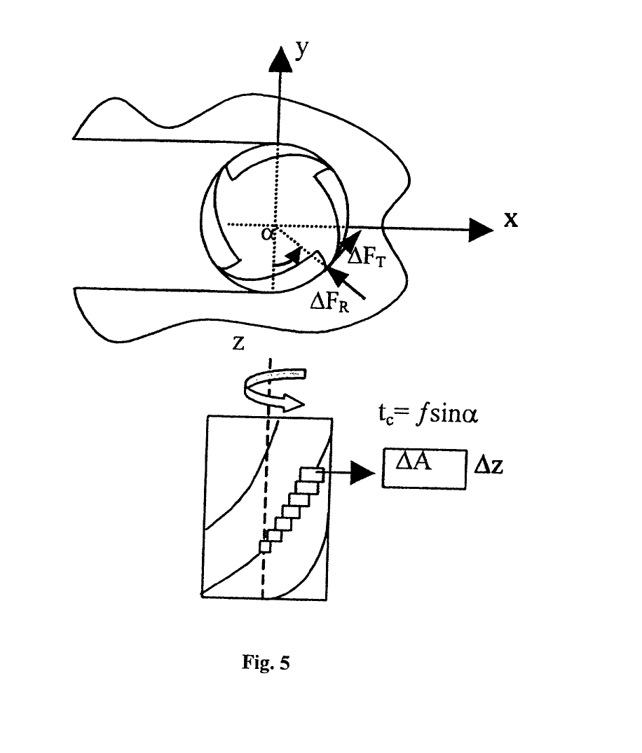

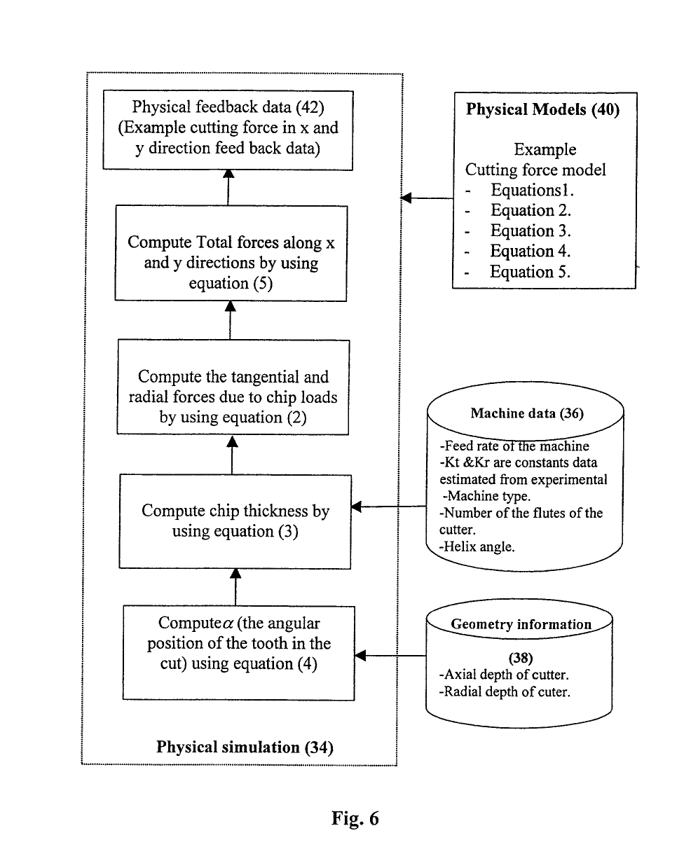

FIGS. 5 and 6 illustrate an example of one of the several physical models (40) for the NC machines (cutting force, thermal, vibration, etc). The milling process is widely used in industry for shaping mechanical components, such as face milling of the top surface of an engine block or peripheral milling of a flexible aircraft turbine impeller. According to this embodiment of the present invention, the physical cutting force model is used in our physical simulation. Several milling force models have been proposed. The instantaneous distributed force model is selected and applied here using the following articles which are hereby incorporated by reference as background material:

(1. Kline, W. A., and DeVor, R. E., The prediction of surface accuracy in ending milling, ASME Journal of Engineering for Industry, 104: 272-278, 1982.

2. Martellotti, M., An analysis of the end milling process, Transactions of ASME, 63:677-700,1941.

3. Martellotti, M., An analysis of the end milling process, part II-down milling, Transactions of ASME, 67:233-251, 1945.

4. Takata, S., Tsai, MD., Sata, T., and Inui, M., A cutting simulation system for Machineability evaluation using a workpiece model, Annals of CIRP, 38:417-420.)

t_{C}−f sinα (1)

where t_{c} is the instantaneous chip thickness, f is the feed (mm/tooth), and α is the angular position of the tooth in the cut; See FIG. 5. By dividing the cutter along the axial depth of cut into N_{z} disks, the chip area (ΔA) is associated with each disk element, ΔA=Δz t_{c}. The tangential and radial forces due to chip loads are, respectively,

ΔF_{T}=K_{T}(ΔA)=K_{T}Δzt_{c}

ΔF_{R}=K_{R}ΔF_{T} (2)

where K_{T} and K_{R} are the cutting coefficients, which vary with feed rate and axial depth of cut. Let the cutter location be specified by the angular position of the bottom of the first flute. The chip thickness of the ith axial segment of the kth flute at the jth angular position of the cutter is

t_{c}(i, j, k)=f sin[α(i, j, k)] (3)

where

$$α ( i , j , k ) = [ \frac{2 π ( k - 1 )}{{N}_{f}} - \frac{2 π j}{{N}_{f} {N}_{θ}} ] + [ ( i - 0.5 ) Δ z ] \frac{tan γ}{R} \qquad ( 4 )$$

γ is the helix angle, jε[1:N₇₄ ] and N_{f} and N₇₄ are the numbers of flutes and angular increments, respectively. For the infinitesimal chip segments, the tangential and radial forces can be readily computed by substituting Eq. (2) into Eq. (3). The total forces acting along the x and y directions at the jth angular position of the cutter are

$${F}_{x} ( j ) = {\sum }_{i = 1}^{{N}_{z}} {\sum }_{k = 1}^{{N}_{f}} - Δ {F}_{R} ( i , j , k ) sin α ( i , j , k ) + Δ {F}_{T} ( i , j , k ) cos α ( i , j , k ) \\ {F}_{y} ( j ) = {\sum }_{i = 1}^{{N}_{z}} {\sum }_{k = 1}^{{N}_{f}} Δ {F}_{R} ( i , j , k ) cos α ( i , j , k ) + Δ {F}_{T} ( i , j , k ) sin α ( i , j , k ) \qquad ( 5 )$$

Swept Volume Generation

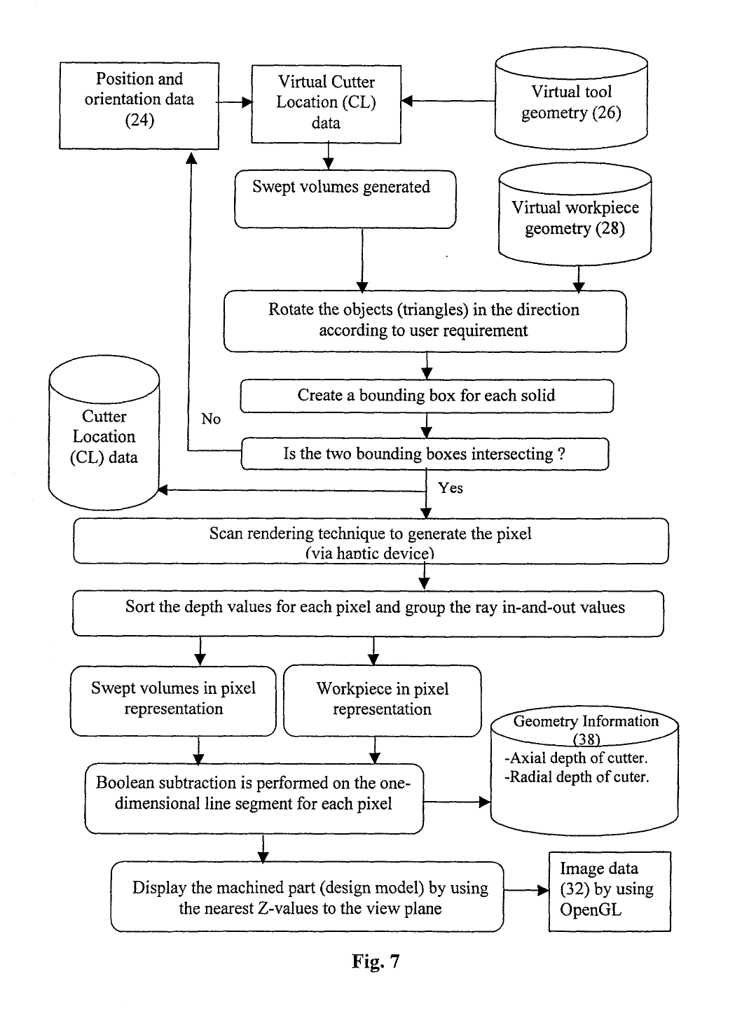

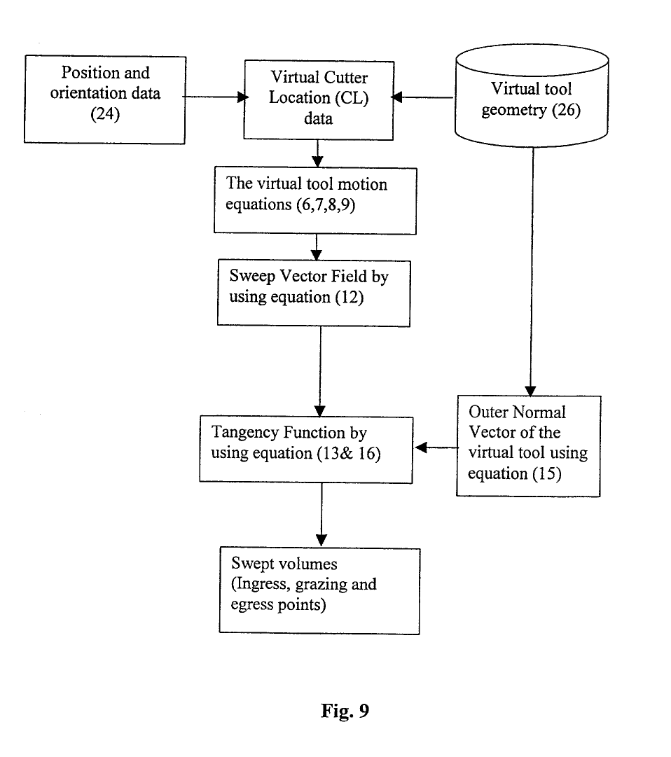

FIGS. 7 and 9, respectively, illustrate a geometrical simulation model and the swept generation model in detail. The CL (cutter location) data in the simulation are obtained by combining the position and orientation data 24 from the 3D Motion Tracker device (3D tracker and data glove) with the virtual tool geometry data 26 (for example, the geometry data for flat-end milling virtual tool are length and the radius of the virtual tool). These data are used to generate the virtual tool motion equations (6), (7), (8) and (9) by linearly interpolating the movements of individual virtual cutter axes. The CL data representing virtual tool tip position and virtual tool orientation are expressed by (x_{c}, y_{c}, z_{c}, i_{c}, j_{c}, k_{c)} where (x_{c}, y_{c}, z_{c}) stands for the virtual cutter tip position and (i_{c}, j_{c}, k_{c}) stands for the virtual cutter orientation. The position of a point on the virtual cutter during machining or cutting can be expressed as:

$$( \begin{matrix}x ( t ) \\ y ( t ) \\ z ( t )\end{matrix} ) = ( \begin{matrix}{x}_{c} ( t ) \\ {y}_{c} ( t ) \\ {z}_{c} ( t )\end{matrix} ) + B \cdot ( \begin{matrix}{x}_{0} \\ {y}_{0} \\ {z}_{0}\end{matrix} ) \qquad ( 6 )$$

where (x₀, y₀, z₀) is a vector representing the initial virtual tool tip position, and B is the rotational transform matrix depending on the roll (β) and pitch (α) angles as follows

$$B = ( \begin{matrix}cos β & - sin α \cdot sin β & cos α \cdot sin β \\ 0 & cos α & - sin α \\ - sin β & sin α \cdot cos β & cos α \cdot cos β\end{matrix} ) \qquad ( 7 )$$

where

α=−tan′(j_{c}(t)f{square root over (t⁵_{c}(t)+k⁵_{c}(t)))}

β=tan⁻¹(i_{c}(t)/k_{c}(t)) (8)

Thus, given one block of CL data:

(x_{c}(0), y_{c}(0), z_{c}(0), i_{c}(0), j_{c}(0), k_{c}(0))→(x_{c}(1), y_{c}(1), z_{c}, (1) i_{c}(1), , the CL data (x_{c}(t), y_{c}(t), z_{c}(t), i_{c}(t), j_{c}(t)), k_{c}(t)) between the initial and final locations can be calculated using linear interpolation. Substituting the obtained (i_{c}(t), j_{c}(t), k_{c}(t)) into Eq. (7) and then Eq. (8), we obtain the rotation transform matrix. Together with the translation vector (x_{c}(t), y_{c}(t), z_{c}(t)), the sweep differential equation is completely defined for rigid sweep of cutter motion as follows:

σₜ(x,₀)=x(t)=ξ(t)+B(t)x₀ (9)

where ξ:[0,1]→Rⁿ and B:[0,1]→SO(n) are smooth functions representing the translation vector (x_{c}(t), y_{c}(t)₎, z,(t)) and rotation matrix(B) of the sweep, respectively; x₀ represents any point on the boundary of object M (virtual tool) in R³.

The set

σₜ(M)=M(t)={σₜ(x);xεM} (10)

is called the t section of M under the sweep σ. The swept volume of M generated by σ is

S_{σ}(M)={σₜ(M):0<t<1} (11)

Solving equation (9) for x₀ and substituting it into the time derivative of Eq. (9), we can obtain the sweep vector field (SVF)

X₉₄ =x(t)=ξ(t)+B(t)B^{T} (t)(x−ξ(t)) (12)

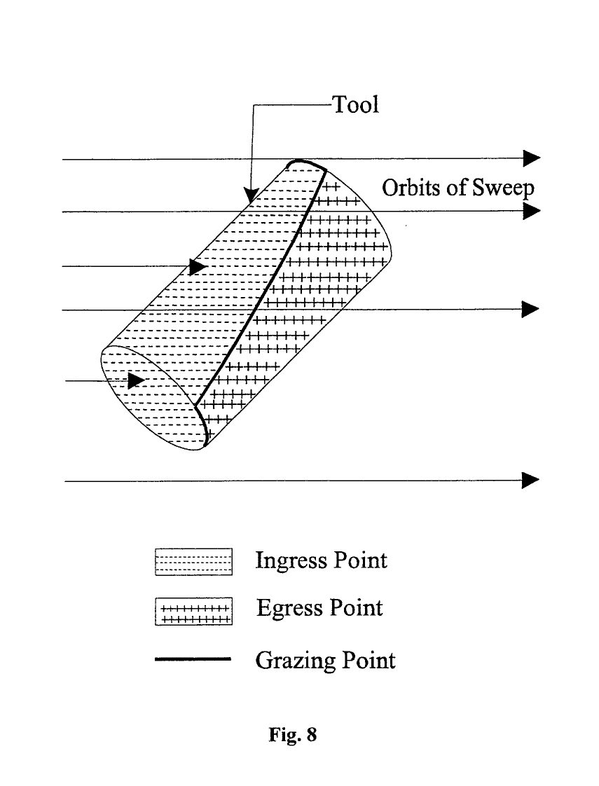

The boundary flow method (BFM) is applied for the representation and calculation of swept volumes by partitioning the boundary of ∂M at each t into ingress, egress and grazing points. The set of ingress (egress) points of M(t), denoted by ∂_M(t) (∂₊M(t)), consists of all points x ε∂M(t) at which X₉₄ (x, t) points into (out of) the interior of M. Those points that are neither ingress nor egress points are called grazing points and denoted by ∂₀M(t). FIG. 8 illustrates the object boundary petitioning of the ingress, egress and grazing points. Mathematically, The above notions can be defined in the context of the tangency function. The tangency function for a sweep of object M is defined as

T(x, t)=<X_{σ}(x, t), N(x, t)> (13)

where <a, b> denotes the inner product of a, b in Rⁿ, and N(x, t) is the unit outward normal vector on the smooth part of M at the point of concern. For the points on a smooth surface, we have:

∂_{—}M(t)=∪{T(x,t)<0,x εM,t ε[0,1]}

∂₊M(t)=∪{T(x,t)>0,x εM,t ε[0,1]}

∂₀M(t)=∪{T(x,t)=0,x εM,t ε[0,1]} (14)

Let the object M and sweep σ be as above; the boundary of the swept volume is given by G(M)\W(M), where G(M)=∂_M(0)∪∂₊M(1)∪{∂₀M(t):0<t<1} is the candidate boundary set which consists of the ingress points of object M at t=0, egress points of M at t=1 and all the grazing points between t=0 and t=1. W(M) denotes the trimming set, which belongs to the interior of some t section of M, and thus it does not belong to the portion of the swept-volume boundary. For the points not on a smooth surface, ingress, egress and grazing points can also be defined easily by using the tangency function.

A fairly straightforward method for calculating the outward normal vector field can be used. Let a surface in three-dimensional space be given which can be expressed by a parametric equation:

$$x ( u , v ) = [ \begin{matrix}x ( u , v ) \\ y ( u , v ) \\ z ( u , v )\end{matrix} ]$$

If x(u, v) is the vector of any point on this surface, the outward normal vector of the surface at this point is

$$N ( x , t ) = \frac{\partial x ( u , v )}{\partial u} \times \frac{\partial x ( u , v )}{\partial v} \qquad ( 15 )$$

The tangency function, therefore, can be obtained from

T(x,t)=<X_{σ}(x, t), N(x, t)>=Xₓ(yᵤzᵥ−yᵥzᵤ)+X_{y}( xᵥzᵤ−xᵤzᵥ) +X_{z}(xᵤ yᵥ−xᵥyᵤ) (16)

where xᵤ, xᵥ, yᵤ, yᵥ,zᵤ and zᵥ stand for

$${x}_{u} = \frac{\partial x ( u , v )}{\partial u} , {x}_{v} = \frac{\partial x ( u , v )}{\partial v}$$

and Xₓ, X_{y}, and X_{z} represent the x, y and z components of X₉₄ (x, t).

Referring back to FIG. 7, now that the swept volumes have been generated, ray casting is one method by which the object can be converted from a solid model to a model having discrete space (pixel space) in a three dimensional array (x, y,depth) [Leu, M. C., Park, S. H., and Wang, K. K., “Geometric Representation of Translational Swept Volumes and Its Applications,” Journal of Engineering for Industry, 108(2): 113-119, May 1986]. The ray-casting technique for Boolean operations creates a new data structure for the solid model, where this data structure is a three-dimensional (x, y, depth) array. The three-dimensional array can be oriented to the direction of view during the design model creation. The operation of Boolean subtraction with ray casting can be performed simply on the one-dimensional line segments representation by the pixel data structure.

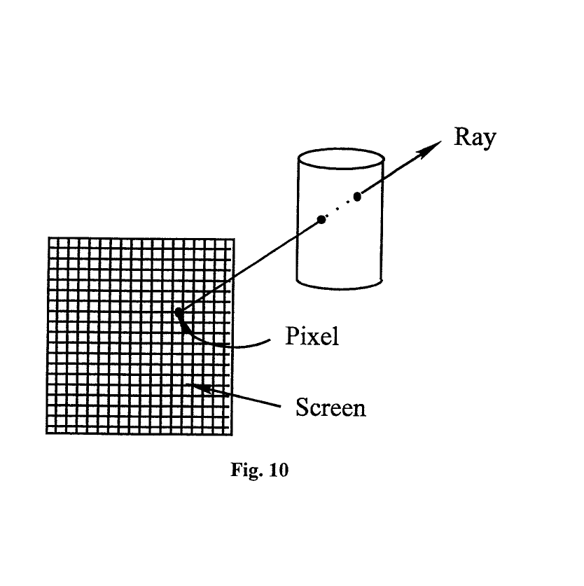

As shown in FIG. 10, to create the pixel data structure of the view plane, a ray starting from the view plane and running through the pixel location is generated. Then the intersection points between surfaces of the solid and the ray are calculated and sorted according to the Z value (depth from the view plane) to determine the initial pixel data structure. Boundary representation (B-rep) solid models are used for surface information in creating the initial ray-casting model of the workpiece. Bounding box and scan-rendering techniques have been integrated with the ray-casting method to accelerate the speed of computation. The bounding box technique is used to restrict the computation in the simulation to localized areas of interest. Scan-rendering techniques are used to replace the ray intersection calculation with a plane intersection calculation, which means the calculation of intersection for all pixels in the same plane will be done together, instead of calculating the intersection of the ray with the surface of the solid model for each pixel. The speed of calculation is usually quite high when modem computer hardware is used.

The last technique to speed up the ray-casting technique is changing the mechanism of transformation of the data between different coordinate systems. In the traditional ray-casting technique, intersection points are computed in the primitive coordinates, which requires transformation of the ray representation from the screen to primitive coordinates. These vectors (rays in parametric representation) are transformed from the screen coordinates to the world coordinates, and then from the world to the primitive coordinate system by multiplying with 4×4 matrices that represent homogeneous transformations. Since the number of rays is huge, the computation of transformation processes reduces the ray-casting efficiency.

To decrease the transformation computation and speed up the ray-casting technique, one can reverse the transformation process. Since the number of points that represent the solid is very small compared to the number of vectors (rays), the primitives are transformed from the primitive coordinate system to the screen coordinate system. After this transformation is done, computation of ray-surface intersections is applied.

This new mechanism of transformation of data has two advantages:

1. Reduction of the number of transformation processes between the relevant coordinate systems.

2. Reduction of the size of the data in the transformation process, where the data set associated with the rays is much larger than the data set of primitives.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications, which are within its spirit and scope as defined by the claims.

We claim:

1. A system that uses a virtual reality environment to create a design model and generate numerically controlled (NC) machining trajectories for use in fabrication of the model, said system comprising:
display means for displaying in real time the three-dimensional images of a virtual environment with virtual machines, tools, workpieces and objects;
manipulation means for navigating through the virtual environment, sizing the virtual objects, and changing the positions and orientations of the virtual objects;
tracking means for measuring the position and orientation of a user's hand;
sensing means for detecting touch or measuring force;
application means for applying a sense of touch or feedback force to the user;
communication means for allowing remote natural communication between multi-users participating in the design creation process; and
computation means for creating said design models and generating said NC machining trajectories by obtaining inputs from said tracking means and said sensing means and generating outputs to said display means, said manipulation means, and said application means; wherein
said system operates in its entirety in real time, and design parameters and machining parameters defined by the operation of said system are output for at least one of direct application to a manufacturing protocol and review by a designer.

2. The system of claim 1, wherein the devices of virtual reality are used to create a design model by carving a workpiece with one or more virtual tools, to simulate the natural physical environment in which freeform models are created by designers, and wherein each of the virtual tools has the geometry of one of a hand tool, a machining tool, and a design tool.

3. The system according to claim 2, wherein the hand tool comprises a knife and the machining tool comprises a milling cutter.

4. The system of claim 1, wherein the design model is created by Boolean subtraction of the virtual tool swept volumes from an initial virtual stock comprised of the workpiece and the virtual tool swept volumes are computed from the geometry and trajectories of the virtual tool using a solid modeling system.

5. The system of claim 1, wherein the actual NC machining trajectories for fabricating the design model from the real workpiece are obtained by applying constraints on the user movements, which represent the physical limitations of the real machining tool and machining process, and by post-processing which includes smoothing the trajectories of the virtual tools that have the geometry of real machining cutters.

6. The system of claim 1 wherein, said manufacturing protocol comprises NC milling machinery.

7. A process for using a virtual reality environment to create a design model and to generate numerically controlled (NC) machining trajectories for use in fabrication of the design model, said process comprising the steps of:
(a) displaying a three-dimensional virtual environment in real time by a computer system;
(b) selecting a virtual workpiece created by a geometry modeler for placement in the virtual environment;
(c) selecting a virtual machine tool for use on the virtual workpiece;
(d) gripping the virtual tool by use of a haptic device;
(e) manipulating the virtual tool in the virtual environment to create a design model while the computer system records positions and orientations of the virtual tool and displays the condition of the virtual workpiece;
(f) simulating geometric changes of the virtual workpiece corresponding to the manipulation of the virtual tool;
(g) providing geometric information from the geometry modeler and material data of the virtual tool and the virtual workpiece as inputs to a physical simulation program;
(h) computing by the physical simulation program at least one physical attribute of the virtual tool selected from the group consisting of heat, cutting force, tool wear, tool vibration and breakage based on the inputs provided in step (g);
(i) transmitting the physical attribute data computed in step (h) to a user;
(j) generating an NC program from machine parameters, geometry of the virtual tool and position and orientation data of the virtual tool; and
(k) providing the NC Program and geometric models of the virtual workpiece and virtual tool from the geometry modeler as inputs for fabrication of the real design model.

8. The method according to claim 7, wherein the displaying recited in step (a) is provided by a head mounted device.

9. The method according to claim 7, wherein the displaying recited in step (a) is provided by a multi-wall display.

10. The method according to claim 8, wherein the displaying recited in step (a) is provided by shutter glasses and a monitor.

11. The method according to claim 7, wherein the physical simulation program in step (h) further includes providing feedback to a user effects and constraints corresponding to errors and limitations in an actual machining process.

12. The method according to claim 11, wherein said feedback provided is graphical.

13. The method according to claim 11, wherein said feedback provided is physical via a haptic device.

14. The method according to claim 11, wherein said feedback provided is audible by providing sounds indicative of errors and limitations in the machinery process.

15. The method according to claim 11, wherein said feedback provided comprises freezing the virtual reality environment with all information saved when the user ignored the effects and constraints for a predetermined amount of time.

16. The method according to claim 7, wherein said computer system generates a swept volume in a solid modeling system of the virtual tool from known dimensions and from measured trajectories based on the position and orientation data recorded in step (e).

17. The method according to claim 16, further comprising converting a solid model obtained from the solid modeling system to a model having discrete space in a three-dimensional array.

18. The method according to claim 17, wherein, the converting is performed by a ray casting system.

19. A process for recording the manipulation of virtual workpiece by a virtual machine tool in a virtual reality (VR) environment to create a design model, comprising the steps of:
(a) initializing a three-dimensional solid workpiece from an input system;
(b) gripping selected virtual objects which simulate real tools;
(c) constraining movement of the virtual objects by applying a force through a haptic interface to the virtual object which is gripped in step (b);
(d) sweeping the virtual objects in the virtual environment continuously within an area of constrained movement recited in step (c);
(e) modeling an in-process virtual workpiece geometry as a solid model by subtracting a swept volume of the virtual object from the virtual workpiece;
(f) recording a position and orientation data of the virtual object during the sweeping recited in step (d) by using VR hardware devices; and
(g) outputting full-scale manufacturing parameters as a design model for use as inputs to automated manufacturing operations for an actual manufacture of the model.
